(19) United States
(12) Patent Application Publication
(10) Pub. No.: US 2023/0222177 A1
(43) Pub. Date: Jul. 13, 2023

(54) AUTOMATED DATASET GENERATION FOR MACHINE LEARNING

(71) Applicant: SAP SE, Walldorf (DE)

(72) Inventor: Pablo Roisman, Sunnyvale, CA (US)

(73) Assignee: SAP SE, Walldorf (DE)

(21) Appl. No.: 17/573,498

(22) Filed: Jan. 11, 2022

(51) Int. Cl. G06K 9/62; G06N 5/02

(52) U.S. Cl. CPC G06K 9/6257; G06K 9/6262; G06N 5/025

(57) ABSTRACT

A computer-implemented method includes detecting attributes and values in rules contained in a rules set. Definitions of the attributes are determined from a data model associated with the rules set. Multiple different data entries having fields corresponding to the attributes are generated by populating the fields with data according to the values detected in the rules and the definitions of the attributes determined from the data model. A labeled dataset is formed using the data entries and logic contained in the rules. At least a portion of the labeled dataset is used to train a machine learning.

### FIELD

The field generally relates to machine learning and to datasets for machine learning.

### BACKGROUND

Machine learning is an advanced technology that can scale and provide better real-time decision compared to rule-based systems. However, there are challenges that prevent many organizations from transitioning from rule-based systems to machine learning based solutions.

Training of machine learning models requires large datasets from which the models can learn. Many systems do not generate sufficient data to create datasets for machine learning. The available data may not have enough examples of rare events to create robust learning in the machine learning model.

The data structures of the systems can change after the machine learning model has been trained. If the data structures do change, the machine learning model will have to be re-trained with new data. Gathering enough data to re-train the machine learning model can take significant time. While gathering data for the re-training, the machine learning model will not perform as expected and may even be unusable.

Machine learning can behave like a black box with no clear reasoning behind how the machine learning model makes decisions. In addition, because the machine learning model is trained on history, which can be biased, and because the machine learning model can ignore new learnings, the machine learning model can have a bias.

Therefore, there continues to be need for improvement in machine learning technologies.

### BRIEF DESCRIPTION OF THE DRAWINGS

FIG. 1 is a block diagram of an example system implementing automated dataset generation.

FIG. 2 is a block diagram of an example method implementing automated dataset generation.

FIG. 3A is a representation of an unlabeled data entry.

FIG. 3B is a representation of a labeled data entry.

FIG. 4 is a block diagram of an example system making a prediction using a machine learning model trained with a dataset from automated dataset generation.

FIG. 5 is a block diagram of an example computing system in which described technologies can be implemented.

FIG. 6 is a block diagram of an example cloud computing environment that can be used in conjunction with the technologies described herein.

FIGS. 7A and 7B are example user interfaces for specifying rules of a rules set.

### DETAILED DESCRIPTION

### Example I—Overview

Described herein are technologies for automated dataset generation. The technologies can generate datasets from rules that represent knowledge in a particular domain. The technologies can generate a sufficiently large dataset to train, validate, and test a machine learning model that can make predictions in the particular domain. The technologies can enable a machine learning model to be developed for domains that do not normally generate a high volume of data. The technologies do not require gathering of field data to generate datasets and can therefore speed up re-training of machine learning models when data structures used in representing information in the domain change. The technologies can generate datasets that account for edge cases and bias.

### Example II—Example System Implementing Automated Dataset Generation

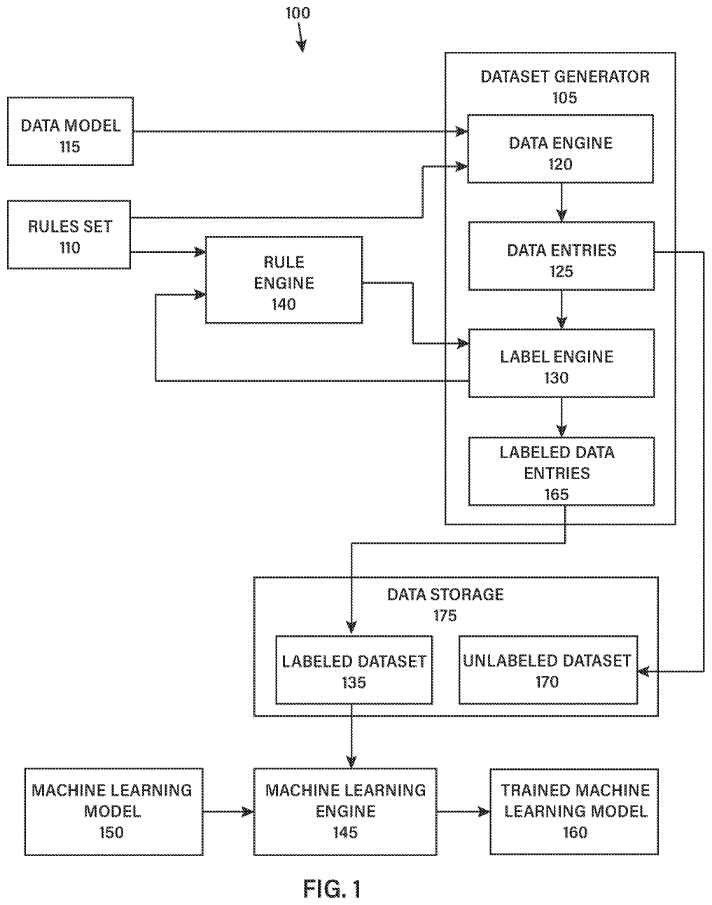

FIG. 1 is a block diagram of an example system 100 implementing automated dataset generation. The system 100 includes a dataset generator 105 that accepts a rules set 110. The rules set 110 includes one or more rules representing knowledge in a particular domain. The dataset generator 105 can accept the rules set 110 in response to a request to generate a dataset. The rules set 110 can be retrieved from an existing rule-based system, or the dataset generator 105 can provide a user interface through which a user, such as a domain expert, can specify the rules in the rules set 110. The rules can be coded in any suitable decision structure, such as if-then-else statements, decision tables, decision trees, and the like. The rules set 110 can be provided in any standard data interchange format. In any of the examples herein, such a data interchange format can take the form of JavaScript Object Notation (JSON), Extensible Markup Language (XML), or the like.

A given rule in the rules set 110 can be a set of one or more conditions with one or more associated results (or actions). A given condition operates on attributes. For example, an example rule for a loan application can have the following conditions: “Age”<18; “Marital Status”=Single; “Number of Dependents”=0; “Annual Income”<50,000; “Credit Score”<760; “Has Late Payments”=false. In this example, Age, Marital Status, Number of Dependents, Annual Income, Credit Score, and Has Late Payments are “condition” attributes and have values. For example, Age <18 includes values in a range from 0 to 17. A rule can have a result that is generated when the conditions are met. Example result for the example loan application rule can be “Approve Loan”=false; “Potential Fraud”=false. “Approve Loan” and “Potential Fraud” are “result” attributes and have values. The rules in the rules set 110 can have a common set of attributes.

The dataset generator 105 can accept a data model 115 that is associated with the rules set 110. A data model can be a stored model that organizes elements of data and standardizes how they relate to one another and to the properties of real-world entities. A data model can also be described as an abstraction layer that can be mapped to relevant tables and attributes of a data source. In the example, the data model 115 includes attributes and definitions (e.g., data types and value domain) for data objects that represent entities. The data model 115 is said to be associated with the rules set 110 if the data model 115 includes data objects with attributes that map to the attributes in the rules of the rules set 110.

A data model can be represented as a network of tables (e.g., database tables or the like). The tables can correspond to data objects, and links can be formed between the tables. For illustrative purposes, for the loan application example, the data model 115 can have an “Applicant” data object with attributes and definitions as indicated in Table 1. The data model 115 can have other data objects besides the Applicant data object (e.g., the Applicant data object can be linked to an “Address” data object, which can contain address information for a loan applicant).

TABLE 1

| VocabularyID | DataObjectID | ID | Name | Description | DataType | ValueDomain |
|---|---|---|---|---|---|---|
| 123456 | 7891011 | 1 | Age | Age | Number | >0 |
| | | | | of the applicant | | <140 |
| 123456 | 7891011 | 2 | Marital Status | Marital status | String | Single, Married, |
| | | | | of the applicant | | Divorced |
| 123456 | 7891011 | 3 | Dependents | Number of dependents | Number | >=0 |
| | | | | of the applicant | | |
| 123456 | 7891011 | 4 | Income | Yearly income | Number | >=0 |
| | | | | of the applicant | | |
| 123456 | 7891011 | 5 | Credit Score | Credit score | Number | >=0 |
| | | | | of the applicant | | <=950 |
| 123456 | 7891011 | 6 | Has Late Payments | Does the applicant | Boolean | True, False |
| | | | | have late payments | | |
| 123456 | 7891011 | 7 | Loan Approved | Is the loan approved | Boolean | True, False |
| | | | | for the applicant | | |
| 123456 | 7891011 | 8 | Fraud Potential | Fraud potential | Boolean | True, False |

In Table 1, the Application data object has a data object ID 7891011 and belongs to a data model having a vocabulary ID 123456. These IDs are merely for illustrative purposes, as are the attributes (e.g., the Name column) and definitions (e.g., the DataType column and ValueDomain). Value domain is a set of values that an attribute is allowed to contain. Value domain can be based on various properties of real-world entities and the data type for the attribute. In the example illustrated in Table 1, the domain of Marital Status has a value domain: Married, Single, and Divorced. The data model 115 can be represented using one or more tables (e.g., as illustrated in Table 1), or using other formats, such as Unified Modeling Language (UML) diagram. The data model 115 can be stored in any standard data interchange format.

The system 100 includes a data engine 120. In the example, the data engine 120 includes logic to parse the rules set 110 and detect the attributes and the values in the rules of the rules set 110. The data engine 120 can include logic to parse the data model 115 and extract attributes and definitions of data objects from the data model 115. The data engine 120 includes logic to map the attributes detected in the rules set 110 to the data object attributes extracted from the data model 115 in order to discover the definitions for the attributes of the rules. The data engine 120 includes logic to generate data entries 125 populated with data according to the values in the rules and the definitions for the attributes obtained from the data model 115.

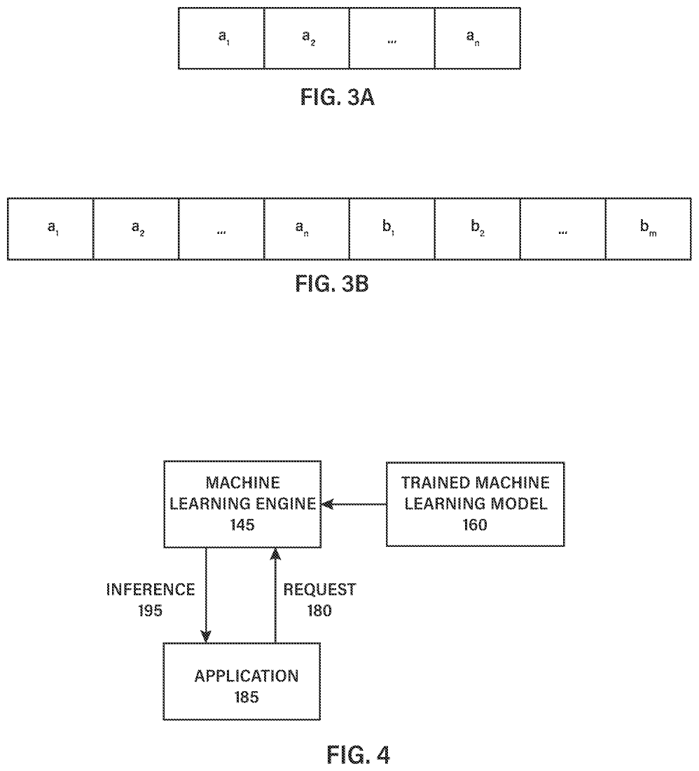

FIG. 3A illustrates a data entry 125 as having fields (or cells) containing a set of values a₁, a₂, . . . , aₙ, which can correspond to the condition attributes of a rule. The set of values a₁, a₂, . . . , aₙ can be assigned according to the values in the rule and the definitions for the attributes obtained from the data model 115. In one example, the data engine 120 can include a random generator that populates the fields (or cells) of the data entry 125 with data values randomly selected from the permissible values of the attributes. The permissible values of the attributes can be determined based on the values found in the rules and the value domains extracted for the attributes from the data model 115.

In machine learning, data labeling, or data annotation, is the process of adding tags or labels to raw data. These labels form a representation of what class of objects the data belongs to and helps a machine learning model learn to identify that particular class of objects when encountered in data without a label. A dataset containing data entries that have been labeled can be referred to as a labeled dataset. Training data for a machine learning model can come from a labeled dataset or an unlabeled dataset, depending on the training strategy. For example, an unlabeled dataset can be used for unsupervised learning, while a labeled dataset can be used for supervised learning.

The data engine 120 generates data entries 125 that are unlabeled. FIG. 3B illustrates a labeled data entry 165 as having fields (or cells) containing a set of values a₁, a₂, . . . , aₙ and a set of labels b₁, b₂, . . . , bₘ (where n, m>=1). The set of values can correspond to the condition attributes of a rule, and the set of labels can correspond to the result attributes of the rule. The set of values a₁, a₂, . . . , aₙ is common between the unlabeled data entry 125 and the labeled data entry 165, and the labeled data entry 165 has additional labeling data (i.e., the set of labels b₁, b₂, . . . , bₘ) compared to the unlabeled data entry 125.

In one example, the dataset generator 105 can include a label engine 130 that generates the labeled data entries 165 from the data entries 125. The label engine 130 can generate a labeled data entry 165 by annotating a data entry 125 with the labeling data. The dataset generator 105 can output the labeled data entries 165 as a labeled dataset 135 and optionally output the data entries 125 as an unlabeled dataset 170. The datasets 165, 170 can be stored in a data storage 175 or provided to a machine learning module. In some cases, the data storage 175 can be part of a machine learning platform.

In one example, the label engine 130 annotates the data entries 125 by executing the rules set 110 on the data entries 125 and using the results of the execution as the labeling data for the corresponding labeled data entries 165. In one example, the label engine 130 can use a rule engine 140 to calculate the result of executing the rules set 110 on data entries 125. For example, the rule engine 140 can receive a data entry 125 from the label engine 130, execute the rules set 110 on the data entry 125, and return the result of the execution to the label engine 130. There will be one result per data entry 125. The label engine 130 can generate a labeled data entry corresponding to a data entry 125 by copying the values of the data entry 125 and adding the result from the rule engine 140 for the data entry 125 as label data. The rule engine 140 can execute the rules set 110 on the data entry by finding the rule in the rules set 110 having conditions that are matched by the data entry and applying the matching rule to the data entry to generate a result. If the rules set 110 is well constructed, there typically will be only one rule matching the data entry.

In the illustrated example, the system 100 includes a machine learning engine 145 that can train and optionally validate and test a machine learning model 150 using the labeled dataset 135. The machine learning engine 145 can receive the machine learning model 150 and the labeled dataset 135 (e.g., via a request to train the machine learning model), or the machine learning engine 145 can retrieve the machine learning model 150 and the labeled dataset 135 from data storage(s) (e.g., in response to a request to train the machine learning model). The machine learning model 150 can be any type of machine learning model (e.g., a neural network model, linear regression, or logistic regression).

Development of a machine learning model typically involves training, validation, and testing, which can use different datasets. In one example, the machine learning engine 145 can include logic to partition the labeled dataset 135 into subsets, where each subset can be used for a particular phase of developing the machine learning model 150. For example, the labeled dataset 135 can be partitioned into a training dataset, a validation dataset, and a testing dataset. The machine learning engine 145 can additionally include logic to preprocess the labeled dataset 135 for consumption by the machine learning model 150. For example, the machine learning 145 can construct input vectors for the machine learning model 150 from the labeled dataset 135 (or subset thereof). The output of the machine learning engine 145 can be a trained machine learning model 160 (i.e., a machine learning model that has been trained to perform a particular task, such as, for example, make a decision on a loan application).

Since the labeled dataset 135 is derived from rule-based logic, the trained machine learning model 160 will perform similarly to the rule-based logic. Thus, an organization can use the system 100 to transition a rule-based system to a machine learning based solution that behaves in a way that is familiar to the organization and that is transparent. Although the system 100 has been illustrated with a loan application example, the system 100 is not limited to this example and can be broadly applied to other domains and tasks.

The dataset generator 105 can be implemented in a computer system. The dataset generator 105 can be stored in one or more computer-readable storage media or computer-readable storage devices. The technologies described herein can be generic to the specifics of operating systems or hardware and can be applied in any variety of environments to take advantage of the described features.

### Example III—Example Method Implementing Automated Dataset Generation

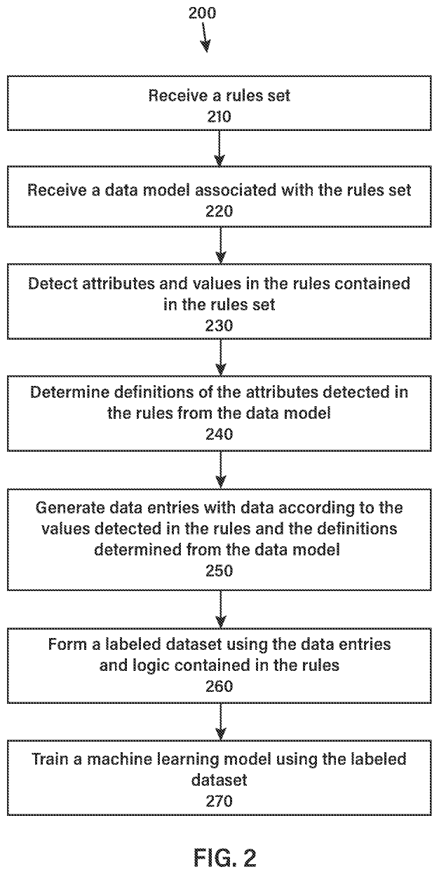

FIG. 2 is a flowchart of an example method 200 of automated dataset generation and can be performed, for example, by the system 100 of FIG. 1. The automated nature of the dataset generation allows sufficiently large datasets to be generated quickly and made available for training, validating, or testing a machine learning model. The datasets can be generated in a manner that captures edge cases, thereby increasing the robustness of the machine learning model trained, validated, and/or tested using the datasets. The datasets can be generated without taking into account historical data, which can enable a trained machine learning model that is not biased.

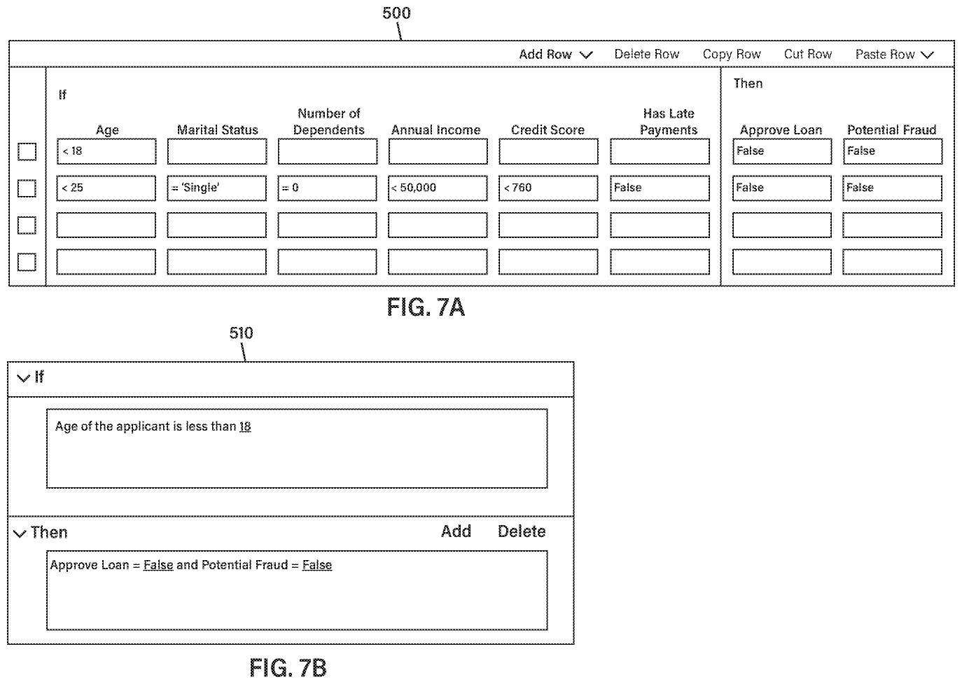

In the example, at 210, the method receives a rules set. In one example, the method can receive the rules set, or receive information to retrieve the rules set, as part of a request to generate a dataset. In another example, the method can present a user interface where a user can define the rules set. The rules of the rules set can be expressed in any suitable decision structure, such as if-then-else statements, decision tables, decision trees, etc. FIGS. 7A and 7B show examples of user interfaces that can be used to specify a rules set. In FIG. 7A, the user interface 500 includes a decision table with rows of cells that can be filled by a user. In FIG. 7B, the user interface 510 includes text fields where a user can enter a rule in text form. For the purpose of reading or writing the rules set, the rules set can be expressed in any standard data interchange format.

In the example, at 220, the method receives a data model associated with the rules set. In one example, the method can receive the data model, or receive information to retrieve the data model, as part of a request to generate a dataset. In another example, the method can present a user interface where a user can select the data model. The data model is associated with the rules set when it contains data objects with attributes that can be mapped to the rules set and corresponding definitions for the attributes. Definitions can be, for example, data types and value domain for the attributes. Table 1 in Example II illustrates an example of a data object of a data model. The structure of the data model generally depends on the domain being modeled. The data model can be received in any standard data interchange format.

In the example, at 230, the method detects attributes and values in the rules contained in the rules set. The method can detect the attributes and values by parsing the rules set. A rule includes a set of conditions that can be true or false or unknown. The conditions contain attributes and can contain values associated with the attributes. The method can detect the attributes in the conditions and any values associated with the attributes. For example, if a condition of a rule is “Age <18”, then the attribute in the condition is Age, and the values associated with the condition are numbers less than 18. A rule also includes a result (or action), which can have attributes with values. The method can detect the attributes and values in the result of a rule.

In the example, at 240, the method determines definitions of the attributes detected in the rules from the data model. In one example, the method extracts attributes and definitions of data objects from the data model and maps the attributes in the rules to the attributes of the data objects. Through the mapping, the definitions of the attributes can be accessed. For example, if a rule has an attribute “Age”, a corresponding attribute can be found in the data model. Once the attribute is found in the data model, any definitions for the attribute can be accessed in the data model. For example, a definition may be that the Age attribute should be an integer and have a nonnegative value.

In the example, at 250, the method generates multiple different data entries having fields populated with data according to the values detected in the rules and the definitions of the attributes determined from the data model. One or more data entries can be generated per rule. Each data entry has fields that correspond to the attributes of the rule (a data entry 125 is illustrated in FIG. 3A). For example, if a rule has an attribute “Age”, the data entry will also have a field “Age”, populated with appropriate data. The method can include determining the permissible values for the attributes from the values in the rule and the definitions (e.g., value domains) of the attributes determined from the data model. For example, a rule may have a condition that “Age <18”. The data model may specify that the attribute “Age” that maps to the rule attribute “Age” is a number and can have values in a range from 0 to 140. If generating a data entry based on this rule and data model, the values used in populating the “Age” field of the data entry will satisfy the following conditions: “Age” is a number (definition from the data model), “Age” is between 0 and 140 (definition from the data model), and “Age” is less than 18 (value from the rule).

In one example, the values used in populating the fields of the data entries can be selected randomly from the permissible values for the attributes corresponding to the fields. Using the previous example of a rule with a condition “Age <18” and a data model that requires age to be a number that is between 0 and 140, the permissible values are numbers in a range from 0 to 17. In this case, a number can be randomly selected within these permissible values and used to populate the “Age” field of the data entry.

In another example, the values used in populating the fields of the data entries can come from existing data. That is, instead of randomly selecting a value that is within the permissible values for an attribute, a value can be selected from existing data that is within the permissible values. The existing data can be data collected from using a rule-based system including the rules set. This approach could be pseudorandom in that the values can be randomly selected from existing data. However, if there is any bias in the existing data, or if the existing data does not capture edge cases, this is likely to be perpetuated in the data entries generated based on the existing data.

In the example, at 260, the method forms a labeled dataset using the data entries and logic contained in the rules set. A labeled dataset contains labeled data entries. In one example, a labeled data entry can be generated by executing the rules set on a data entry to obtain a result and then annotating the data entry with the result (i.e., the result can be added as label data to the unlabeled data entry to form the labeled data entry, as described in Example II). Executing the rules set on a data entry involves finding the rule in the rules set having conditions that are matched by the data entry and applying the matching rule to the data entry to generate a result. Typically, only one rule will match the data entry. The process of executing the rules set on a data entry and annotating or labeling the data entry with the result of the execution can be performed for the data entries obtained in operation 250 to form the labeled dataset.

In the example, at 270, the method includes training (or re-training) a machine learning model using the labeled dataset. Training can include applying at least a portion of the labeled dataset to the machine learning model as a training dataset. The method can optionally include validating and/or testing the machine learning model using the labeled dataset. In one example, the method can include dividing the labeled dataset into subsets, and each subset can be used for one aspect of developing the machine learning model. For example, the labeled dataset can be partitioned into training, validation, and testing datasets. In some cases, instead of partitioning the labeled dataset, operations 210-260 can be used to generate multiple labeled datasets that can be used for various aspects of developing the machine learning model.

In one example, the method can receive a modified rules set and/or a modified data model. The method can repeat the operations 210-260 using the modified rules set and/or modified data model in order to obtain a new labeled dataset, which can be used to re-train the machine learning model.

The method 200 and any of the other methods described herein can be performed by computer-executable instructions (e.g., causing the computing system to perform the method) stored in one or more computer-readable media (e.g., storage or other tangible media) or stored in one or more computer-readable storage devices. Such methods can be performed in software, firmware, hardware, or combinations thereof. Such methods can be performed at least in part by a computer system (e.g., one or more computing devices).

### Example IV—Example System Implementing Prediction with Automated Dataset Generation

FIG. 4 is a block diagram illustrating use of the trained machine learning model 160 generated by the system 100 of FIG. 1 and method 200 of FIG. 2 for prediction. As shown, the machine learning engine 145 can accept a request 180 for a prediction from an application 185. The machine learning engine 145 can determine that the trained machine learning model 160 has been trained to provide the prediction and retrieve the trained machine learning model 160 from storage if necessary. The machine learning engine 145 can run the trained machine learning model 160 with the data supplied in the request 180 as input to the trained machine learning model 160. The machine learning engine 145 can transmit an inference 195 to the application 185. The inference 195 includes the prediction by the trained machine learning model 160 and can further include other information, such as explainability.

### Example V—Example Method Implementing Prediction with Automated Dataset Generation

In one example, the example method 200 described in Example III can further include receiving a request for a prediction by the trained machine learning model. The method can include extracting input data for the trained machine learning model from the request and providing the input data to an input layer of the trained machine learning model. The trained machine learning model can generate a prediction for the input data. The method can prepare an inference that includes the prediction and other information, such as explainability of the machine learning model or the prediction of the machine learning model, and return the inference to the requester.

### Example VI—Example Automated Dataset Generation in Loan Processing

Table 2 shows an example decision table rule built to help in a decision of loan approvals. A domain expert has defined the set of attributes affecting the decision to approve or deny a loan request and event to protect potential fraud. In the example shown in Table 2, the expert has elected to evaluate the applicants by age, marital status, number of dependents, annual income, credit score, and whether the applicant has late payments.

TABLE 2

| Conditions | | | | | | Result | |
|---|---|---|---|---|---|---|---|
| | Marital | Number of | Annual | Credit | Has Late | Approve | Potential |
| Age | Status | Dependents | Income | Score | Payments | Loan | Fraud |
| <18 | | | | | | False | False |
| <25 | =Single | =0 | <50,000 | <760 | False | False | False |
| <25 | =Single | =0 | <50,000 | >759 | False | True | False |
| <25 | =Married | <2 | <70,000 | >720 | False | True | False |
| • | • | • | • | • | • | • | • |
| • | • | • | • | • | • | • | • |
| • | • | • | • | • | • | • | • |
| | | | | >720 | True | False | True |
| >80 | | | | | | False | False |

Each non-header row in Table 2 defines a rule as a set of conditions and a result. The decision table can contain hundreds or even thousands of such rows. For each loan request submitted into the system, the rule engine loops over the decision table and executes the rule logic row by row until the matching row is found and sets the approval and fraud flags. In the example of Table 2, the rule logic is if the conditions are true, then the rule evaluates to the corresponding result. One example in the decision table is that loans for applicants younger than 18 or older than 80 should not be approved. Another example is to raise potential fraud alert for applicants that have late payments with high credit score.

The high effort to maintain such a decision table, the dependency on specific rule-engine, and runtime performance issues can be solved by transitioning the rule-based system to a machine learning based solution. The automated dataset generation described herein can enable this transition by providing sufficient data for training of a machine learning model. Since the automated dataset generation is based on rule logic, the machine learning model trained with the dataset obtained from the automated dataset generation will behave similarly to the rule-based system.

To generate the dataset for the machine learning based solution, the attributes and values in the rules in Table 2 are detected, as described in operation 230 of example method 200. In the example of Table 2, the attributes are Age, Marital Status, Number of Dependents, Annual Income, Credit Score, Has Late Payments, Approve Loan, and Potential Fraud. The attributes related to conditions in the rules are Age, Marital Status, Number of Dependents, Annual Income, Credit Score, and Has Late Payments. The attributes related to result are Approve Loan and Potential Fraud.

The attributes detected from the rules can be mapped to a data model that is associated with the rules to determine definitions of the attributes detected in the rules, as described in operation 240 in example method 200. Data entries can be generated with values according to the values detected in the rules and the definitions determined from the data model, as described in operation 250 in example method 200. Table 3 shows an example of data entries that could be generated. The dataset illustrated in Table 3 is an unlabeled dataset.

TABLE 3

| | Marital | Number of | Annual | Credit | Has Late |
|---|---|---|---|---|---|
| Age | Status | Dependents | Income | Score | Payments |
| 16 | Single | 0 | 62,126 | 580 | False |
| 30 | Single | 0 | 50,000 | 695 | True |
| 75 | Divorced | 0 | 126,284 | 721 | False |
| 56 | Married | 1 | 83,003 | 761 | True |
| . | . | . | . | . | . |
| . | . | . | . | . | . |
| . | . | . | . | . | . |
| 42 | Divorced | 2 | 212,150 | 695 | False |
| 87 | Married | 0 | 85,030 | 590 | True |

A labeled dataset can be formed by executing the rules in Table 2 on the data entries in Table 3, as described in operation 260 of example method 200. Table 4 shows the labeled dataset based on Tables 2 and 3.

TABLE 4

| Data | | | | | | Label(s) | |
|---|---|---|---|---|---|---|---|
| | Marital | Number of | Annual | Credit | Has Late | Approve | Potential |
| Age | Status | Dependents | Income | Score | Payments | Loan | Fraud |
| 16 | Single | 0 | 62,126 | 580 | False | False | False |
| 30 | Single | 0 | 50,000 | 695 | True | False | False |
| 75 | Divorced | 0 | 126,284 | 721 | False | True | False |
| 56 | Married | 1 | 83,003 | 761 | True | True | False |
| • | • | • | • | • | • | • | • |
| • | • | • | • | • | • | • | • |
| • | • | • | • | • | • | • | • |
| 42 | Divorced | 2 | 212,150 | 695 | False | True | False |
| 87 | Married | 0 | 85,030 | 590 | True | False | false |

The labeled dataset can be used to train (or re-train), validate, and/or test a machine learning model, as described in operation 270 of example method 200.

### Example Computing Systems

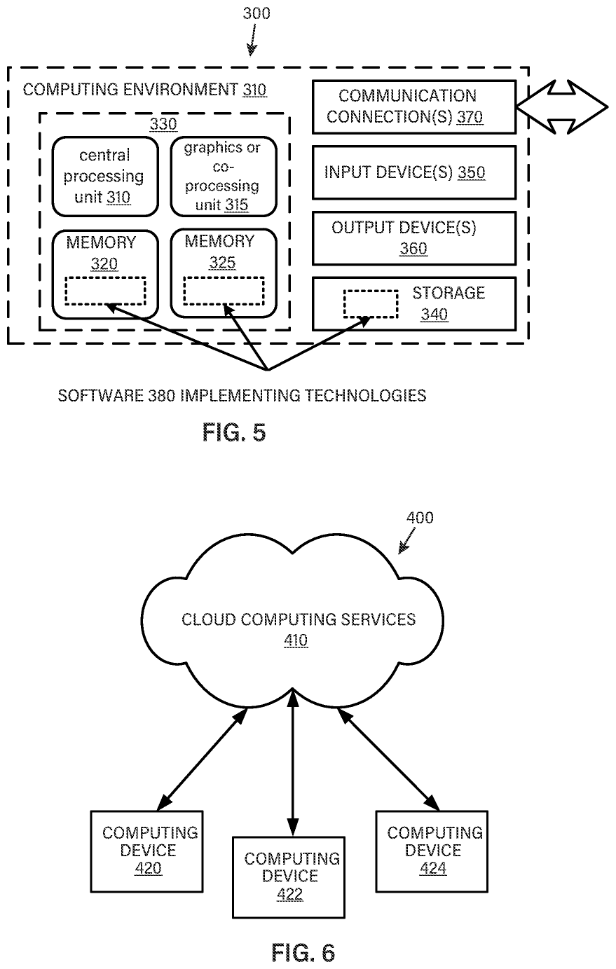

FIG. 5 depicts an example of a suitable computing system 300 in which the described innovations can be implemented. The computing system 300 is not intended to suggest any limitation as to scope of use or functionality of the present disclosure, as the innovations can be implemented in diverse computing systems.

With reference to FIG. 5, the computing system 300 includes one or more processing units 310, 315 and memory 320, 325. In FIG. 5, this basic configuration 330 is included within a dashed line. The processing units 310, 315 execute computer-executable instructions, such as for implementing the features described in the examples herein. A processing unit can be a general-purpose central processing unit (CPU), processor in an application-specific integrated circuit (ASIC), graphics processing unit (GPU), tensor processing unit (TPU), quantum processor, or any other type of processor. In a multi-processing system, multiple processing units execute computer-executable instructions to increase processing power. For example, FIG. 5 shows a central processing unit 310 as well as a graphics processing unit or co-processing unit 315. The tangible memory 320, 325 can be volatile memory (e.g., registers, cache, RAM), non-volatile memory (e.g., ROM, EEPROM, flash memory, etc.), or some combination of the two, accessible by the processing unit(s) 310, 315. The memory 320, 325 stores software 380 implementing one or more innovations described herein, in the form of computer-executable instructions suitable for execution by the processing unit(s) 310, 315.

A computing system 300 can have additional features. For example, the computing system 300 includes storage 340, one or more input devices 350, one or more output devices 360, and one or more communication connections 370, including input devices, output devices, and communication connections for interacting with a user. An interconnection mechanism (not shown) such as a bus, controller, or network interconnects the components of the computing system 300. Typically, operating system software (not shown) provides an operating environment for other software executing in the computing system 300, and coordinates activities of the components of the computing system 300.

The tangible storage 340 can be removable or non-removable, and includes magnetic disks, magnetic tapes or cassettes, CD-ROMs, DVDs, or any other medium which can be used to store information in a non-transitory way and which can be accessed within the computing system 300. The storage 340 stores instructions for the software 380 implementing one or more innovations described herein.

The input device(s) 350 can be an input device such as a keyboard, mouse, pen, or trackball, a voice input device, a scanning device, touch device (e.g., touchpad, display, or the like) or another device that provides input to the computing system 300. The output device(s) 360 can be a display, printer, speaker, CD-writer, or another device that provides output from the computing system 300, e.g., actuators or some mechanical devices like motors, 3D printers, and the like.

The communication connection(s) 370 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the context of computer-executable instructions, such as those included in program modules, being executed in a computing system on a target real or virtual processor (e.g., which is ultimately executed on one or more hardware processors). Generally, program modules or components include routines, programs, libraries, objects, classes, components, data structures, etc. that perform particular tasks or implement particular abstract data types. The functionality of the program modules can be combined or split between program modules as desired in various embodiments. Computer-executable instructions for program modules can be executed within a local or distributed computing system.

For the sake of presentation, the detailed description uses terms like “determine” and “use” to describe computer operations in a computing system. These terms are high-level descriptions for operations performed by a computer and should not be confused with acts performed by a human being. The actual computer operations corresponding to these terms vary depending on implementation.

### Computer-Readable Media

Any of the computer-readable media herein can be non-transitory (e.g., volatile memory such as DRAM or SRAM, nonvolatile memory such as magnetic storage, optical storage, or the like) and/or tangible. Any of the storing actions described herein can be implemented by storing in one or more computer-readable media (e.g., computer-readable storage media or other tangible media). Any of the things (e.g., data created and used during implementation) described as stored can be stored in one or more computer-readable media (e.g., computer-readable storage media or other tangible media). Computer-readable media can be limited to implementations not consisting of a signal.

Any of the methods described herein can be implemented by computer-executable instructions in (e.g., stored on, encoded on, or the like) one or more computer-readable media (e.g., computer-readable storage media or other tangible media) or one or more computer-readable storage devices (e.g., memory, magnetic storage, optical storage, or the like). Such instructions can cause a computing system to perform the method. The technologies described herein can be implemented in a variety of programming languages.

### Example Cloud Computing Environment

FIG. 6 depicts an example cloud computing environment 400 in which the described technologies can be implemented, including, e.g., the systems described systems herein. The cloud computing environment 400 comprises cloud computing services 410. The cloud computing services 410 can comprise various types of cloud computing resources, such as computer servers, data storage repositories, networking resources, etc. The cloud computing services 410 can be centrally located (e.g., provided by a data center of a business or organization) or distributed (e.g., provided by various computing resources located at different locations, such as different data centers and/or located in different cities or countries).

The cloud computing services 410 are utilized by various types of computing devices (e.g., client computing devices), such as computing devices 420, 422, and 424. For example, the computing devices (e.g., 420, 422, and 424) can be computers (e.g., desktop or laptop computers), mobile devices (e.g., tablet computers or smart phones), or other types of computing devices. For example, the computing devices (e.g., 420, 422, and 424) can utilize the cloud computing services 410 to perform computing operations (e.g., data processing, data storage, and the like).

In practice, cloud-based, on-premises-based, or hybrid scenarios can be supported.

### ADDITIONAL EXAMPLES

Additional examples based on principles described herein are enumerated below. Further examples falling within the scope of the subject matter can be configured by, for example, taking one feature of an example in isolation, taking more than one feature of an example in combination, or combining one or more features of one example with one or more features of one or more other examples.

Example 1 is a computer-implemented method including detecting attributes and values in rules contained in a rules set; determining definitions of the attributes detected in the rules from a data model associated with the rules set; generating multiple different data entries having fields corresponding to the attributes detected in the rules, the generating including populating the fields with data according to the values detected in the rules and the definitions of the attributes determined from the data model, forming a labeled dataset using the data entries and logic contained in the rules; and training a machine learning model using at least a portion of the labeled dataset.

Example 2 includes the subject matter of Example 1, and further specifies that the definitions determined from the data model include value domains for the attributes detected in the rules, and that generating multiple different data entries having fields corresponding to the attributes detected in the rules includes determining permissible values for the fields based on the values detected in the rules and the value domains from the data model.

Example 3 includes the subject matter of Example 2, and further specifies that generating multiple different data entries having fields corresponding to the attributes detected in the rules further includes randomly assigning values to the fields of the data entries from the permissible values.

Example 4 includes the subject matter of Example 2, and further specifies that generating multiple different data entries having fields corresponding to the attributes detected in the rules further includes assigning values to the data entries within the permissible values and from existing data with values for the attributes and the permissible values.

Example 5 includes the subject matter of any one of Examples 1-4, and further specifies that forming the labeled dataset includes selecting a data entry from the data entries, executing the rules set on the data entry to obtain a result, and using the result as a label for the data entry.

Example 6 includes the subject matter of Example 5, and further specifies that executing the rules set on the data entry to obtain a result includes finding a rule in the rules set having a set of conditions that matches the data entry and applying the found rule to the data entry.

Example 7 includes the subject matter of any one of Examples 5-6, and further specifies that using the result as a label for the data entry includes adding the result to the data entry to form a labeled data entry.

Example 8 includes the subject matter of any one of Examples 1-7, and further includes receiving a new rules set and a new data model associated with the new rules set; forming a new labeled dataset from the new rules set and the new data model; and re-training the machine learning model with the new labeled dataset.

Example 9 includes the subject matter of any one of Examples 1-8, and further includes validating the machine learning model using at least a portion of the labeled dataset.

Example 10 includes the subject matter of any one of Examples 1-9, and further includes testing the machine learning model using at least a portion of the labeled dataset.

Example 11 includes the subject matter of any one of Examples 1-10, and further includes making a prediction using the machine learning model.

Example 12 is a computing system including one or more processing units coupled to memory; and one or more computer readable storage media storing instructions that when executed by the one or more processing units cause the computing system to perform operations including: detecting attributes and values in rules contained in a rules set; determining definitions of the attributes detected in the rules from a data model associated with the rules set; generating multiple different data entries having fields corresponding to the attributes detected in the rules, the generating comprising populating the fields with data according to the values detected in the rules and the definitions of the attributes determined from the data model; forming a labeled dataset, wherein the forming comprises selecting a data entry from the data entries, executing the rules set on the data entry to obtain a result, and using the result as a label for the data entry; and forming a training dataset from the labeled dataset; and applying the training dataset to a machine learning model during training of the machine learning model.

Example 13 includes the subject matter of Example 12, and further specifies that the definitions determined from the data model include value domains for the attributes detected in the rules, and that generating multiple different data entries having fields corresponding to the attributes detected in the rules includes determining permissible values for the fields based on the values detected in the rules and the value domains from the data model.

Example 14 includes the subject matter of Example 13, and further specifies that generating multiple different data entries having fields corresponding to the attributes detected in the rules further includes randomly assigning values to the fields of the data entries from the permissible values.

Example 15 includes the subject matter of Example 13, and further specifies that generating multiple different data entries having fields corresponding to the attributes detected in the rules further includes assigning values to the fields of the data entries within the permissible values and from existing data with values for the attributes.

Example 16 includes the subject matter of any one of Examples 12-15, and further specifies that the operations further include validating or testing the machine learning model using at least a portion of the labeled dataset.

Example 17 includes the subject matter of any one of Examples 12-16, and further specifies that the operations further include making a prediction using the machine learning model.

Example 18 is one or more non-transitory computer-readable storage media storing computer-executable instructions for causing a computer system to perform operations including: detecting attributes and values in rules contained in a rules set; determining definitions of the attributes detected in the rules from a data model associated with the rules set; generating multiple different data entries having fields corresponding to the attributes detected in the rules, the generating including populating the fields with data according to the values detected in the rules and the definitions of the attributes determined from the data model; forming a labeled dataset, wherein the forming includes selecting a data entry from the data entries, executing the rules set on the data entry to obtain a result, and using the result as a label for the data entry; forming a training dataset from the labeled dataset; and applying the training dataset to a machine learning model during training of the machine learning model.

Example 19 includes the subject matter of Example 18, and further specifies that the definitions determined from the data model include value domains for the attributes detected in the rules, and wherein generating multiple different data entries having fields corresponding to the attributes detected in the rules includes: determining permissible values for the fields based on the values detected in the rules and the value domains specified in the data model; and randomly assigning values to the fields of the data entries from the permissible values.

Example 20 includes the subject matter of Example 18, and further specifies that the definitions determined from the data model include value domains for the attributes detected in the rules, and that generating multiple different data entries having fields corresponding to the attributes detected in the rules includes: determining permissible values for the fields based on the values detected in the rules and the value domains from the data model; and assigning values to the fields of the data entries within the permissible values and from existing data obtained from use of a rule-based system including the rules set.

### Example Implementation

Although the operations of some of the disclosed methods are described in a particular, sequential order for convenient presentation, such manner of description encompasses rearrangement, unless a particular ordering is required by specific language set forth herein. For example, operations described sequentially can in some cases be rearranged or performed concurrently.

### Example Alternatives

The technology has been described with a selection of implementations and examples, but these preferred implementations and examples are not to be taken as limiting the scope of the technology since many other implementations and examples are possible that fall within the scope of the disclosed technology. The scope of the disclosed technology includes what is covered by the scope and spirit of the following claim.

1. A computer-implemented method comprising:
detecting attributes and values in rules contained in a rules set;
determining definitions of the attributes detected in the rules from a data model associated with the rules set;
generating multiple different data entries having fields corresponding to the attributes detected in the rules, the generating comprising populating the fields with data according to the values detected in the rules and the definitions of the attributes determined from the data model;
forming a labeled dataset using the data entries and logic contained in the rules; and
training a machine learning model using at least a portion of the labeled dataset.

2. The method of claim 1, wherein the definitions determined from the data model comprise value domains for the attributes detected in the rules, and wherein generating multiple different data entries having fields corresponding to the attributes detected in the rules comprises determining permissible values for the fields based on the values detected in the rules and the value domains from the data model.

3. The method of claim 2, wherein generating multiple different data entries having fields corresponding to the attributes detected in the rules further comprises randomly assigning values to the fields of the data entries from the permissible values.

4. The method of claim 2, wherein generating multiple different data entries having fields corresponding to the attributes detected in the rules further comprises assigning values to the data entries within the permissible values and from existing data with values for the attributes and the permissible values.

5. The method of claim 1, wherein forming the labeled dataset comprises selecting a data entry from the data entries, executing the rules set on the data entry to obtain a result, and using the result as a label for the data entry.

6. The method of claim 5, wherein executing the rules set on the data entry to obtain a result comprises finding a rule in the rules set having a set of conditions that matches the data entry and applying the found rule to the data entry.

7. The method of claim 5, wherein using the result as a label for the data entry comprises adding the result to the data entry to form a labeled data entry.

8. The method of claim 1, further comprising:
receiving a new rules set and a new data model associated with the new rules set;
forming a new labeled dataset from the new rules set and the new data model; and
re-training the machine learning model with the new labeled dataset.

9. The method of claim 1, further comprising validating the machine learning model using at least a portion of the labeled dataset.

10. The method of claim 1, further comprising testing the machine learning model using at least a portion of the labeled dataset.

11. The method of claim 1, further comprising making a prediction using the machine learning model.

12. A computing system comprising:
one or more processing units coupled to memory; and
one or more computer readable storage media storing instructions that when executed by the one or more processing units cause the computing system to perform operations comprising:
detecting attributes and values in rules contained in a rules set;
determining definitions of the attributes detected in the rules from a data model associated with the rules set;
generating multiple different data entries having fields corresponding to the attributes detected in the rules, the generating comprising populating the fields with data according to the values detected in the rules and the definitions of the attributes determined from the data model;
forming a labeled dataset, wherein the forming comprises selecting a data entry from the data entries, executing the rules set on the data entry to obtain a result, and using the result as a label for the data entry;
forming a training dataset from the labeled dataset; and
applying the training dataset to a machine learning model during training of the machine learning model.

13. The computing system of claim 12, wherein the definitions determined from the data model comprise value domains for the attributes detected in the rules, and wherein generating multiple different data entries having fields corresponding to the attributes detected in the rules comprises determining permissible values for the fields based on the values detected in the rules and the value domains from the data model.

14. The computing system of claim 13, wherein generating multiple different data entries having fields corresponding to the attributes detected in the rules further comprises randomly assigning values to the fields of the data entries from the permissible values.

15. The computing system of claim 13, wherein generating multiple different data entries having fields corresponding to the attributes detected in the rules further comprises assigning values to the fields of the data entries within the permissible values and from existing data with values for the attributes.

16. The computing system of claim 12, wherein the operations further comprise validating or testing the machine learning model using at least a portion of the labeled dataset.

17. The computing system of claim 12, wherein the operations further comprise making a prediction using the machine learning model.

18. One or more non-transitory computer-readable storage media storing computer-executable instructions for causing a computer system to perform operations comprising:
detecting attributes and values in rules contained in a rules set;
determining definitions of the attributes detected in the rules from a data model associated with the rules set;
generating multiple different data entries having fields corresponding to the attributes detected in the rules, the generating comprising populating the fields with data according to the values detected in the rules and the definitions of the attributes determined from the data model;
forming a labeled dataset, wherein the forming comprises selecting a data entry from the data entries, executing the rules set on the data entry to obtain a result, and using the result as a label for the data entry;
forming a training dataset from the labeled dataset; and
applying the training dataset to a machine learning model during training of the machine learning model.

19. The one or more non-transitory computer-readable storage media of claim 18, wherein the definitions determined from the data model comprise value domains for the attributes detected in the rules, and wherein generating multiple different data entries having fields corresponding to the attributes detected in the rules comprises:
determining permissible values for the fields based on the values detected in the rules and the value domains specified in the data model; and
randomly assigning values to the fields of the data entries from the permissible values.

20. The one or more non-transitory computer-readable storage media of claim 18, wherein the definitions determined from the data model comprise value domains for the attributes detected in the rules, and wherein generating multiple different data entries having fields corresponding to the attributes detected in the rules comprises:
determining permissible values for the fields based on the values detected in the rules and the value domains from the data model; and
assigning values to the fields of the data entries within the permissible values and from existing data obtained from use of a rule-based system including the rules set.
